(19) United States
(12) Patent Application Publication
(10) Pub. No.: US 2020/0210661 A1
(43) Pub. Date: Jul. 2, 2020

(54) SYSTEMS AND METHODS FOR OBJECT TRACKING

(71) Applicant: Johanes Frederick Niels Swenberg, Los Gatos, CA (US)

(72) Inventor: Johanes Frederick Niels Swenberg, Los Gatos, CA (US)

(21) Appl. No.: 16/732,779

(22) Filed: Jan. 2, 2020

Related U.S. Application Data
(60) Provisional application No. 62/787,495, filed on Jan. 2, 2019.

(51) Int. Cl. G06K 7/10; G06K 7/14

(52) U.S. Cl. CPC G06K 7/10821; G06K 7/1443; G06K 7/1408

(57) ABSTRACT

A system and a method of tracking an object is disclosed. The system includes a network server associated with one or more electronic devices associated with one or more users. The system can receive, via the network server, an image of an object, from which item information associated with the object may automatically be identified. The item information can be identified by scanning an identifier associated with the object. The item information can include location information. The item information can be used to identify a rule that may include a flag associated with the object. Based at least in part on the rule identified based at least on the item information, the system can identify a user. The system can generate a notification associated with the object and transmit the notification to the user.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57 and should be considered a part of this specification.

### BACKGROUND

### Field

The systems and methods discloses herein relates broadly to systems for tracking objects and sharing information related to tracked objects with intended recipients.

### Description of the Related Art

Object tracking systems can track objects by providing location information. The object tracking systems can use a scanner to detect a unique identifier of an item, collect information about the item, and send the information to recipients. A network server in communication with different scanners or user mobile devices can be utilized to transmit signals between the different scanners or user mobile devices that can include information about the item.

### SUMMARY

According to one aspect, an object tracking system is provided. The object tracking system can include a non-transitory data storage, a remote server, and a hardware processor. The non-transitory data storage can be configured to store computer executable instructions for an object tracking system, a plurality of rules, and information associated with a plurality of tracked objects. The remote server can be in communication with the non-transitory data storage and a plurality of electronic devices associated with a plurality of users. The hardware processor can be in communication with the non-transitory data storage and can be programmed to execute the computer executable instructions in the non-transitory data storage. The object tracking system can receive, via the remote server, from a first electronic device of the plurality of electronic devices, a first image associated with a first object of the plurality of objects, the first image captured and generated by the first electronic device. The object tracking system can automatically scan the first image to identify item information associated with the first object, wherein the item information comprises location information. The object tracking system can access the plurality of rules from the non-transitory data storage. The object tracking system can identify at least a first rule from the plurality of rules based at least in part on the item information, wherein the first rule comprises a flag associated with the first object, and wherein the flag identifiers the first object as missing. The object tracking system can determine a first user of the plurality of users based in part on the first rule. The object tracking system can generate and transmit a notification to a second electronic device of the plurality of electronic devices, the notification associated with the first object and comprising at least a subset of the item information, and wherein the second electronic device is associated with the first user. The flag can cause the object tracking system to automatically generate and transmit the notification to the second electronic device when first image associated with the first object is received.

The item information can be captured using an image capturing device of the first electronic device. The item information can be captured by scanning and detecting an identifier associated with the first object using the image capturing device. The identifier can be modular and affixed to the first object, and wherein the identifier can be removed at a later time. The identifier can be a QR code on the first object. The computer executable instructions can further cause the object tracking system to receive, via the remote server, device information from the first electronic device, and wherein the device information comprises a temporal information and a location information associated with the first electronic device. The temporal information and a location information associated with the first electronic device. The temporal information can include a time when the item information was captured and generated by the first electronic device. The location information can include a location of the first electronic device when the item information was captured and generated by the first electronic device. The device information associated with the first electronic device can be captured and stored when the item information is captured and generated by the first electronic device. The item information associated with the first electronic device can include at least one or more of the following: an identifier associated with the first object, a picture or a video associated with the first object, or description associated with the first object. The information associated with the plurality of tracked objects comprise: (1) object identifiers associated with each of the plurality of tracked objects, (2) owner identifiers associated with each of the plurality of tracked objects, and (3) missing object flags associated with each of the plurality of tracked objects. The first rule of the plurality of rules may indicate which recipients of the plurality of recipients receive the notification associated with the first object. The first rule of the plurality of rules may be provided by the first user. The first user can customize the at least the first rule of the plurality of rules. The first rule may indicate what types of information associated with the first object the first user receives. The device information may not include identification information of the first electronic device. The notification can be at least one of the following: a text message, an email, a telephone call, or a notification on a mobile application.

According to another aspect, a method of tracking an object using an object tracking system is provided. The method can include receiving, via a remote server, from a first electronic device, a first image associated with a first object of a plurality of tracked objects, the first image captured and generated by the first electronic device. The method can include automatically scanning the first image to identifier item information associated with the first object, wherein the item information comprises location information associated with the first object. The method can include accessing a plurality of rules from a non-transitory data storage associated with the remote server. The method can include identifying a first rule from the plurality of rules based at least in part on the item information, wherein the first rule comprises a flag associated with the first object, and wherein the flag identifies the first object as missing. The method can include identifying a first user based at least in part on the first rule. The method can include generating and transmitting, via the remote server, a notification to a second electronic device, wherein the second electronic device is associated with the first user, and wherein the notification is associated with the first object and comprises at least a subset of the item information. The flag may cause the object tracking system to automatically generate and transmit the notification to the second electronic device when first image associated with the first object is received.

The method can further include receiving, via the remote server, device information from the first electronic device, the device information associated with the first electronic device. The device information associated with the first electronic device may be captured and stored when the first image is captured and generated by the first electronic device. The notification may be at least one of the following: a text message, an email, a telephone call, or a notification on a mobile application.

For purposes of summarizing the disclosure, certain aspects, advantages and novel features are discussed herein. It is to be understood that not necessarily all such aspects, advantages or features will be embodied in any particular embodiment of the invention and an artisan would recognize from the disclosure herein a myriad of combinations of such aspects, advantages or features.

### BRIEF DESCRIPTION OF THE DRAWINGS

FIG. 1 is an example of an object tracking system.

FIGS. 2A and 2B illustrate another example of an object tracking system.

FIG. 3 is another example of an object tracking system.

FIG. 4 is another example of an object tracking system.

FIG. 5 is another example of an object tracking system.

### DETAILED DESCRIPTION

Systems and methods which represent various embodiments and example applications of the present disclosure will now be described with reference to the drawings. In this description, references to “an embodiment,” “one embodiment,” or the like, mean that the particular feature, function, structure or characteristic being described is included in at least one embodiment of the technique introduced herein and may be included in multiple embodiments. Occurrences of such phrases in this specification do not necessarily all refer to the same embodiment. On the other hand, the embodiments referred to are also not necessarily mutually exclusive.

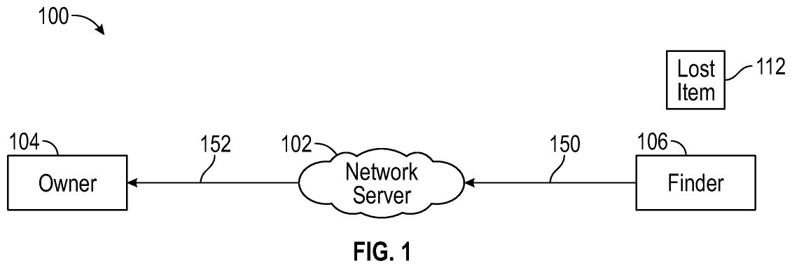

FIG. 1 illustrates an example object tracking system 100. The object tracking system 100 can include a network server 102 that can establish communication with and receive data from the one or more user devices. The object tracking system 100 can track an object by detecting an identifier of the object. The identifier may be unique or non-unique. For example, the identifier can include, but not limited to, a QR code, a barcode, or any proprietary technology used to uniquely identify an object.

The network server 102 may store a plurality of identifiers associated with objects registered with the network server 102. The plurality of identifier associated with the objects may be stored within a data storage unit associated with the network server 102. The plurality of identifier may include: (1) object identifiers as described herein, (2) user identifiers, and (3) flags for objects as described herein. User identifiers may be unique or may not be unique for each user. User identifiers may be used to identify different users associated with the network server 102 to track different registered objects. Flags can be generated by users for one or more objects-in-interest. The flags can cause the network server 102 to automatically generate and transmit notifications associated with objects-in-interest. For example, when the network server 102 receives item information or image associated with an object-in-interest, the flag can generate notification associated with the object-in-interest and send the notification to one or more designated users. The one or more designated users may include a user that created the flag.

Detection of an identifier of an object may be performed in different ways. Detection may be performed optically. For example, an object-of-interest (e.g., parcel to be delivered) may include a QR code or a barcode as its identifier, which may be detected using a camera on a mobile device. The identifier may be detected in a picture or in a video. The identifier can include information that can uniquely identify a given object. For example, an identifier for a shipment can include information of the seller, the shipping company, recipient address, shipping date, item description, parcel departure location, and the like.

In some examples, identifiers can utilize industry standard codes or include proprietary codes. Identifier may have non-copiable elements to prevent unauthorized duplication. Identifiers may have advanced imaging features (e.g. holographic or non-visual elements) to provide additional data or security. The identifiers may include passive elements such as radio-frequency identification (RFID) requiring additional sensing elements. In some examples, image identification technology or system may be utilized to capture or generate information associated to an item.

In a non-limiting example, detection or capture of an identifier of an item-of-interest can be done by scanning a video or a picture of the item using a device (for example, a mobile communication device). The video or the picture of the item can be captured by a user device (e.g., a mobile device). After a video or a picture has been taken, the network server 102 can use one or more computer processors to receive and access the video or the picture from the user device. The receipt and access of the video or the picture may be done automatically. Alternatively, the network server 102 may use one or more computer processors to access the video or the picture once the video or the picture is made available for the network server 102. The network server 102 can process the video or the picture to search for any identifier present in the video or the picture. In some examples, the user device can process the video or the picture to search for any identifiers. For example, a mobile application can be used to process the video or the picture to search for any identifier present in the picture or the video.

The network server 102 may or may not store the video or the picture prior to or after processing the video or the picture. The network server 102 may process different types of picture and video formats. If detecting is done with a camera image, the network server 102 of the object tracking system 100 may access and store additional information such as the picture of the item and what is visible in the field of view of the camera. The detection can be through use of a camera of a user device. The detection can be done using a mobile application running on a user device.

Optionally, detection or capture of an identifier may be performed manually or automatically without taking a video or a picture of the item or the identifier. For example, an item-of-interest may include a QR code that may include an identifier of the item-of-interest. As discussed herein, the identifier may be or may not be unique to the item-of-interest Additionally, the QR code can be associated with a specific web address (or a hypertext markup language (HTML)) such that a device may, after scanning the QR code, be directed to the specific web address. Once the device has been directed to the specific web address and be connected to the network server 102 of the object tracking system 100, the network server 102 can request location-based information and the identifier of the item-of-interest from the device. Additionally or alternatively, the network server 102 can request time information from the device. Such time information can include, for example, time-of-access of the device to the specific web address.

The network server 102 of the object tracking system 100 can take an action based on the information it receives from the device. For example, the action taken by the network server 102 can be based at least in part on the identifier (for example, an identifier associated with the QR code) received from the device. The action taken by the network server 102 can include, but not limited to, generating and sending an email, generating and texting a text message, storing the identifier and the location-based information at a remote storage, generate a web-based notification or updates, and the like. Recipients of an email, a text message, or notifications can be an owner of the item-of-interest, individuals authorized by the owner of the item-of-interest, or any individuals identified by a specific set of rules preconfigured by the owner or the network server 102.

The communication between the network server 102 and one or more user devices can be wireless. In the object tracking system 100 shown in FIG. 1, the network server 102 can be wirelessly connected with an owner 104 and a finder 106. The owner 104 can have a wireless device (e.g., a mobile device or a tablet) that can wirelessly communicate with the network server 102. Likewise, the finder 106 can have a wireless device (e.g., a mobile device or a tablet) that can wirelessly communicate with the network server 102.

The network server 102 can receive location information or time information from a device used to capture an identifier of an object. Additional information regarding the location information and the time information will be provided below. In some examples, the network server 102 can automatically collect location information or time information. In other examples, the network server 102 can collect location information or time information only after an identifier of an object has been identified by a scanner or a user device. The location information can be associated with the object or associated with an electronic device that was used to capture, scan, or detect the identifier of the object. The identifier of the object may include predetermined location information that can be identified or determined by the network sever 102.

In some examples, the object tracking system 100 may not be able to track objects that has not been registered with the network server 102. Tracking an item may require registering the item with the network server 102. Registering an object can be done by anyone. In other examples, registering an object can only be done by an owner of the object. Registering an object with the network server 102 can include generating a unique or non-unique identifier for the object, an identifier for an owner of the object, or a flag to track the object. As discussed herein, the owner can create a flag to track his/her object by automatically causing the network server 102 of the object tracking system 100 to generate and transmit a notification to the owner when the network server 102 receives information associated with the tracked object. The flag can be generated using a virtual user interface of the network server 102. The flag may be modified at any time.

The network server 102 can store one or more rules that can be used to determine which recipients will receive what information regarding what objects. For example, one of the rules can indicate that individuals A, B, and C will receive location information related to the “Stanley Cup.” In another example, one of the rules may indicate that individuals X, Y, and Z will receive time or location information of a shipment. The rules can also indicate a frequency at which information is transmitted to recipients. Additionally or alternatively, the rules may determine how time information or location information is transmitted to different recipients. For example, time information or location information may be transmitted via a text message, an email, a notification on a mobile application, a telephone call, and the like. Additionally or alternatively, the rules may specify what types of information described herein is transmitted to recipients. The rules can be access, modified, or customized by the individuals registered with the network server 102.

In a non-limiting example shown in FIG. 1, an owner 104 may register one of his items with the network server 102 and place a identifier on an item. The identifier may be integrated with the item or be modular. For example, the identifier may be affixed to the item such that it may be removed at a later time.

The registered item may be misplaced and the owner 104 can track the item using the network server 102. The owner 104 may generate or set up a flag (for example, an alert) associated with a registered item such that the network server 102 of the object tracking system 100 can track the registered item. For example, the flag can indicate that the registered item owned by the owner 104 has been misplaced. The flag can be set up via the network server 102 or a virtual user interface associated with the network server 102. The flag can include information associated with the registered item (for example, item description, an image of the item, and the identifier of the item). The flag can cause the network server 102 of the object tracking system 100 to automatically generate and transmit a notification to the owner 104 of the misplaced registered item. The notification can include various types of information associated with the misplaced registered item discussed herein, including, but not limited to, picture of the misplaced registered item, description of the misplaced registered item, location of the misplaced registered item, identifier of the misplaced registered item, and the like.

A finder 106 may find an item 112 and can take a picture or a video of the item 112 using a mobile device, for example. The mobile device of the finder 106 can process (for example, scan, or capture a picture or a video) the unique device ID of the item 112 to determine or retrieve information related to the item 112. Information related to the item 112 may be provided to the finder 106, who can then upload the information to the network server 102. Alternatively, the information related to the item 112 may be automatically transmitted to the network server 102 via transmission 150. The transmission 150 can include, but not limited to, item description including shape or color, item category (e.g., laptop, key, phone, and the like), and item size. The transmission 150 can advantageously include location and time data related to the mobile device of the finder 106. Additionally or alternatively, the transmission 150 can include time or location information associated with when and where the identifier of the item 112 was processed by the mobile device of the finder 106.

The network server 102 can use the information contained in the transmission 150 to confirm whether the item 112 is a registered item that the owner 104 misplaced. Once the network server 102 confirms that the information contained in the transmission 150 matches the information of the registered item that belongs to the owner 114, the network server 102 can send a transmission 152 to the owner 104. In some examples, the transmission 152 can be sent to a mobile device of the owner 104. The wireless transmission 152 can advantageously include the location and time data related to the mobile device of the finder 106. In some examples, the transmission 152 can include information related to the item 112. Additionally or alternatively, the transmission 152 may not include identifying information associated with the mobile device of the finder 106 or any other devices not associated with the owner 104.

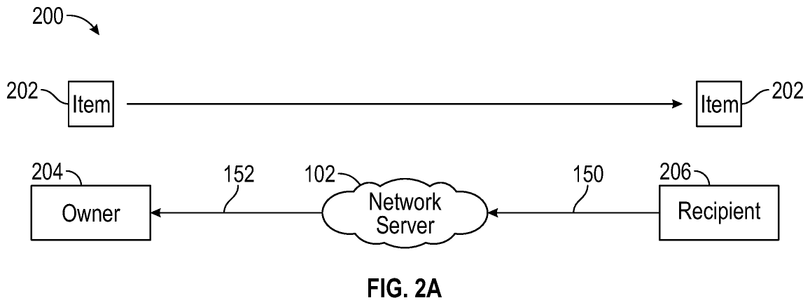

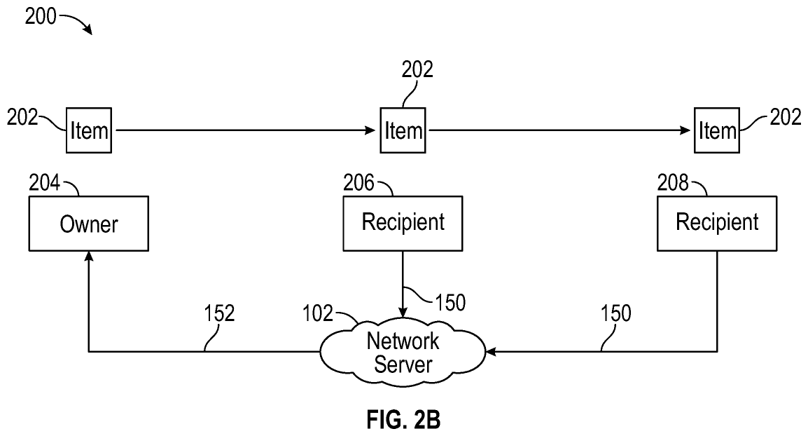

FIGS. 2A and 2B illustrate an example object tracking system 200. In an example of the object tracking system 200 shown in FIG. 2, the object tracking system 200 can include the network server 102 that can establish wireless communication with an owner 204 and a recipient 206. For example, the wireless communication between the network server 102 and the owner 204 and between the network server 102 and the recipient 206 can be made via mobile devices and existing wireless communication systems.

In a non-limiting example shown in FIG. 2A, the owner 204 can register an item 202 with the network server 102. As discussed above, the owner 204 can place a identifier on the item 202 and register the identifier of the item 202 with the network server 102. The network server 102 may or may not store the identifier of the item 202. The network server 102 can associate the owner 204 with the identifier of the item 202. For example, a car dealership can register a car (e.g., a silver 2018 Acura RSX) with the network server 102. A identifier of the car may be the VIN number or a license plate of the silver 2018 Acura RSX.

As discussed above, the network server 102 can track registered items. Additionally or alternative, the network server 102 can track unregistered items. After the owner 204 ships the item 202 to the recipient 206, the recipient 206 can take a picture or record a video of the item 202 upon receipt. For example, a new owner of the silver 2018 Acura RSX can take a picture or record a video of the car after it has been delivered. The network server 102 can automatically process the picture or the video of the delivered item 202 to detect the item 202. Once the item 202 is detected from the picture or the video captured by the recipient 206, the network server 102 can collect information related to the item 202 via a transmission 150. Optionally, the transmission 150 can include time or location information related to the recipient 206 or a device associated with the recipient 206. The time or location information related to the recipient 206 or the device associated with the recipient 206 can be captured and collected when the information related to the item (or associated with the item) is captured or detected. For example, if the item 202 was delivered to the recipient 206 at 10 Main Street, Irvine, Calif. 92614 on Jan. 1, 2018 at 3:35 P.M. Pacific Time, the network server 102 can collect such data via the transmission 150 upon detecting the item 202 from the picture or video captured by the recipient 206. Optionally, the network server can determine and collect GPS location coordinates instead of mailing addresses. In some examples, the network server 102 can collect time zone information from the recipient 206.

The network server 102 can use the information stored in the transmission 150 to determine that the recipient 206 has received the item 202 from the owner 204. For example, the owner 204 may be a seller of the item 202 and the recipient 206 can be a buyer of the item 202. The network server 102 can send the owner 204 a transmission 152 upon determining that the recipient 206 has received the item 202. The transmission 152 can include various types of information including, but not limited to, delivery time, delivery location, recipient name, item description, and the like.

In a non-limiting example shown in FIG. 2B, the recipient 206 can deliver the item 202 to a recipient 208. The recipient 208 can, upon receipt of the item 202, take a picture or record a video of the item 202. When the recipient 208 takes the picture or records the video, the network server 102 can access the picture or the video from the recipient 208 (e.g., accessing the picture or the video from a mobile device owned by the recipient 208) to determine whether the item 202 has been delivered to the recipient 208. Upon determining that the item 202 has been safely delivered from the recipient 206 to the recipient 208, the network server 102 can send the transmission 152 to the owner 204.

Optionally, people registered to the network server 102 of the object tracking system 200 can receive the transmission 152 from the network server 102. For example, the recipient 206 or the recipient 208 can register with the network server 102 of the object tracking system 200 such that they too can receive the transmission 152. As discussed above, the transmission 152 can serve as a confirmation that the item 202 has been safely delivered from the owner 204 to the recipient 206, and then from the recipient 206 to the recipient 208. For example, Amazon may have UPS deliver an item to a recipient. Amazon and the recipient may be registered with the network server 102 to receive updates related to a delivery of the item. In such example, UPS can also register network server 102 to confirm receipt of the item by the recipient. In another example, the item 202 may be the Olympic torch and people may be interested in seeing the torch in person. People may register with the network server 102 to receive updates regarding the Olympic torch to receive updates from the network server 102 where the torch is located at what time.

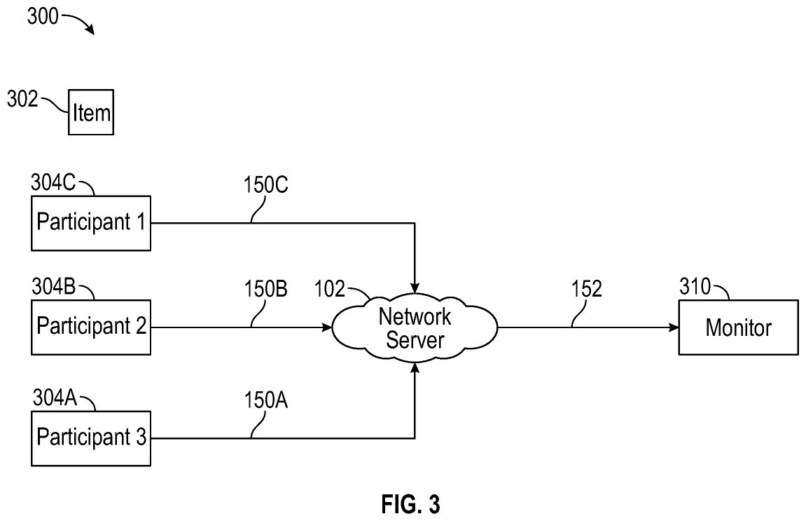

FIG. 3 illustrates another example object tracking system 300. The object tracking system 300 can include the network server 102 that is in communication with numerous participants 304A, 304B, and 304C. The communications between the participants 304A, 304B, and 304C can be via mobile devices capable of establishing wireless communication. In some examples, the wireless communication between the participants 304A, 304B, and 304C and the network server 102 can require the participants 304A, 304B, and 304C registering with the network server 102. The network server 102 can be in wireless communication with the monitor 310. The monitor 310 can be individuals, groups, or entities interested in receiving updates regarding the participants 304A, 304B, or 304C, or regarding an item 302.

In a non-limiting example shown in FIG. 3, participants 304A, 304B, and 304C can “check-in” with an item 302 located at “location A.” The item 302 can include an identifier as discussed above. As discussed above, identifiers can be detected using image recognition technology that is different from simple barcode scanning. People can “check-in” by taking a picture or recording a video of the item 302. When people take pictures or record videos that show the item 302, the network server 102 or mobile devices of the participants 304A, 304B, and 304C can apply various detection technologies to detect and identify the identifier of the item 302. As discussed herein, an example detection technology can utilize QR codes. When the participants 304A, 304B, and 304C “check-in,” their mobile devices send transmissions 150A, 150B, and 150C to the network server 102. The transmissions 150A, 150B, and 150C can include identifier of the item 302, location of the participants 304A, 304B, and 304C, image of the item 302, personal information of the participants 304A, 304B, and 304C, and the like. The personal information of the participants 304A, 304B, and 304C can include the participants' names, ages, gender, and the like. In some examples, the participants 304A, 304B, and 304C can provide instructions to the network server 102 to determine what of their personal information, if any, are shared via the transmissions 150A, 150B, and 150C.

The network server 102 can generate the transmission 152 using the transmissions 150A, 150B, or 150C. Types of information included in the transmission 152 can depend on setting provided by monitor 310. For example, if the monitor 310 has subscribed to information or updates regarding the participants 304A and 304C, but not 304B, the transmission 152 will include information regarding the participants 304A and 304C, but not information regarding the participant 304B. The transmission 152 from the network server 102 to the monitor 310 can information including, but not limited to, names of the participants, identifier of the item 302, location of the item 302, locations of the participants, name of the item 302, and the like.

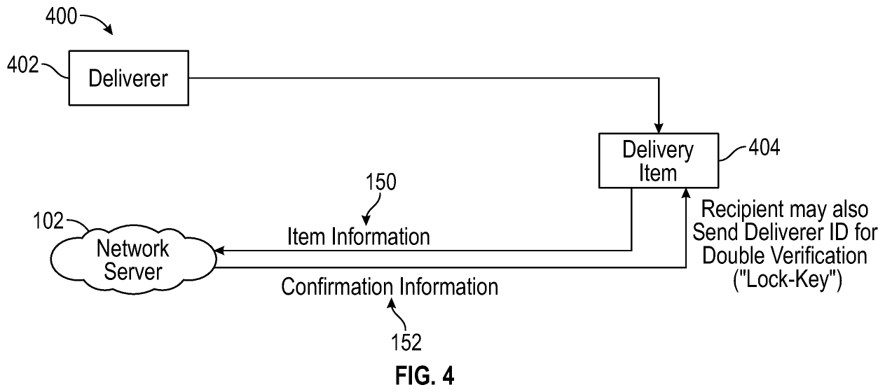

FIG. 4 illustrates an example object tracking system 400. The object tracking system 400 can advantageously help delivery companies or persons to determine that they are delivering a correct item. The object tracking system 400 can include the network server 102 that can communicate with a deliverer 402 via a mobile device. In the example shown in FIG. 4, a delivery item 404 can have a identifier that is registered with the network server 102. When picking up the delivery item 404, the deliverer 402 can use a mobile device take a picture or record a video of the delivery item 404. The mobile device can use the picture or the video of the delivery item 404 to collect and determine information associated with the delivery item 404. As discussed above, such information can be accessed or retrieved by detecting the identifier of the delivery item 404. The mobile device can send the information associated with the delivery item 404 to the network server 102 via the transmission 150. The network server 102 can use the information in the transmission 150 to generate and send a notification via the transmission 152 to indicate that the deliverer 402 is picking up a correct or incorrect item.

In some examples, an intended recipient of the delivery item 404 can use a deliverer ID for double verification and prevent fraudulent pick up of the delivery item 404. The intended recipient of the delivery item 404 may have been given a delivery ID by a delivery provider which can be used to determine whether a correct deliverer is picking up the delivery item 404. For example, the intended recipient of the delivery item 404 may have received UPS 1234 as a delivery person ID. The intended recipient can transmit the delivery person ID to the network server 102 to associate the delivery item 404 with the delivery person ID. When the deliverer 402 picks up the delivery item 404 and sends transmission 150 to the network server 102, the network server 102 can request the deliverer 402 to confirm his delivery person ID. Once it receives a response from the deliverer 402, the network server 102 can relay the response to the intended recipient. Depending on the response from the deliverer 402, the network server 102 can generate and transmit an alert or a message to a relevant party (e.g., the police, delivery provider, intended recipient, and the like). The network server 102 can therefore can ensure that a correct item is being picked up and delivered by a correct delivery person.

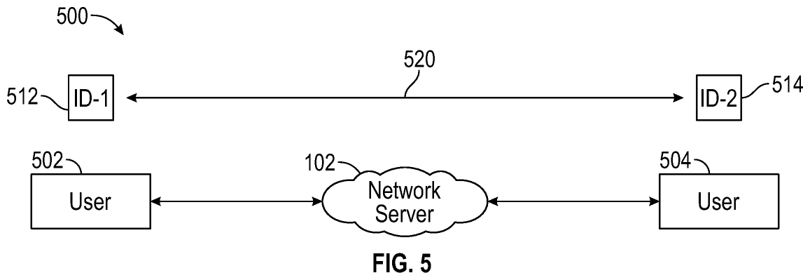

An example object tracking system 500 is shown in FIG. 5. The object tracking system 500 can include the network server 102 and can provide a “lock and key” service for users. In the example shown in FIG. 5, the network server 102 can communicate with a user 502 and a user 504. The user 502 and the user 504 can each have a identifier. As shown in FIG. 5, the user 502 can have an ID 512 while the user 504 can have an ID 514. The IDs may be generated dynamically for a specific location or time of the parties to further enhance anonymity and security.

The IDs of the user 502 and the user 504 can verify or authenticate connection 520 between the monitor 502 and the monitor 504. The user 502 can communicate with the network server 102 to transmit device information associated with the user 502. The device information associated with the user 502 can include the ID 512. Likewise, the user 504 can communicate with the network server 102 to transmit device information associated with the user 504. The device information associated with the user 504 can include the ID 514. The network server 102 can compare the device information received from the user 502 and the user 504 to establish direction communication 520 between the user 502 and the user 504.

In some examples, the IDs 512 and 514 can be used to anonymously verify or authenticate the connection. In other examples, the network server 102 may require the user 502 and the user 504 be in the same location to establish the connection 520. This can be like a lock and key to additionally unlock services requiring all parties' participation and presence.

While certain embodiments of the inventions have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a sub combination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language used herein, such as, among others, “can,” “might,” “may,” “for example,” and the like, unless specifically stated otherwise, or otherwise understood within the context as used, is generally intended to convey that certain embodiments include, while other embodiments do not include, certain features, elements or states. Thus, such conditional language is not generally intended to imply that features, elements or states are in any way required for one or more embodiments or that one or more embodiments necessarily include logic for deciding, with or without author input or prompting, whether these features, elements or states are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Terms such as “substantially,” “about,” “approximately” or the like as used in referring to a relationship between two objects is intended to reflect not only an exact relationship but also variances in that relationship that may be due to various factors such as the effects of environmental conditions, common error tolerances, manufacturing variances, or the like. It should further be understood that although some values or other relationships may be expressed herein without a modifier, these values or other relationships may also be exact or may include a degree of variation due to various factors such as the effects of environmental conditions, common error tolerances, or the like. For example, when referring to measurements, about a specified measurement can, in some contexts, refer to a measurement variation of around equal to or less than ±10%, ±5%, ±2%, or ±1% (such as a variation of ±10%, ±5%, ±2%, ±1%, ±0.8%, ±0.5%, or ±0.3%) from the specified measurement.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

What is claimed is:

1. An object tracking system comprising:
a non-transitory data storage configured to store (1) computer executable instructions for an object tracking system, (2) a plurality of rules, and (3) information associated with a plurality of tracked objects;
a remote server in communication with the non-transitory data storage and a plurality of electronic devices associated with a plurality of users; and
a hardware processor in communication with the non-transitory data storage and programmed to execute the computer executable instructions to cause the object tracking system to:
receive, via the remote server, from a first electronic device of the plurality of electronic devices, a first image associated with a first object of the plurality tracked objects, the first image captured and generated by the first electronic device;
automatically scan the first image to identify item information associated with the first object, wherein the item information comprises location information associated with the first object;
access the plurality of rules from the non-transitory data storage;
identify a first rule from the plurality of rules based at least in part on the item information, wherein the first rule comprises a flag associated with the first object, and wherein the flag identifies the first object as missing and comprises information associated with the first object;
identify a first user of the plurality of users based at least in part on the first rule;
generate and transmit, via the remote server, a notification to a second electronic device of the plurality of electronic devices, wherein the notification is associated with the first object and comprising at least a subset of the item information, and wherein the second electronic device is associated with the first user,
wherein the flag is configured to cause the object tracking system to automatically generate and transmit the notification to the second electronic device upon capture and generation of the first image associated with the first object.

2. The object tracking system of claim 1, wherein the first image is captured using an image capturing device of the first electronic device.

3. The object tracking system of claim 1, wherein the item information is captured by scanning and detecting an identifier associated with the first object using an image capturing device of the first electronic device.

4. The object tracking system of claim 3, wherein the identifier is modular and affixed to the first object, and wherein the identifier may be removed at a later time.

5. The object tracking system of claim 3, wherein the identifier is a QR code on the first object.

6. The object tracking system of claim 1, wherein the computer executable instructions further cause the object tracking system to receive, via the remote server, device information from the first electronic device, and wherein the device information comprises a temporal information associated with the first electronic device and a location information associated with the first electronic device.

7. The object tracking system of claim 6, wherein the temporal information comprises a time when the first image was captured and generated by the first electronic device, and wherein the location information comprises a location of the first electronic device when the first image was captured and generated by the first electronic device.

8. The object tracking system of claim 6, wherein the device information associated with the first electronic device is received when the first image is captured and generated by the first electronic device.

9. The object tracking system of claim 1, wherein the item information associated with the first object comprises at least one or more of the following: an identifier associated with the first object, a picture or a video associated with the first object, or description associated with the first object.

10. The object tracking system of claim 1, wherein the information associated with the plurality of tracked objects comprise: (1) object identifiers associated with each of the plurality of tracked objects, (2) user identifiers associated with each of the plurality of tracked objects, and (3) missing object flags associated with each of the plurality of tracked objects.

11. The object tracking system of claim 1, wherein the first rule indicates which user of the plurality of user receives the notification associated with the first object.

12. The object tracking system of claim 1, wherein the flag of the first rule is provided by the first user.

13. The object tracking system of claim 1, wherein the first user can customize the first rule or the flag.

14. The object tracking system of claim 1, wherein the first rule identifies what types of information associated with the first object the first user receives.

15. The object tracking system of claim 1, wherein the device information does not include identification information of the first electronic device.

16. The object tracking system of claim 1, wherein the notification can be at least one of the following: a text message, an email, a telephone call, or a notification on a mobile application.

17. A method of tracking an object using an object tracking system, the method comprising:
receiving, via a remote server, from a first electronic device, a first image associated with a first object of a plurality of tracked objects, the first image captured and generated by the first electronic device;
automatically scanning the first image to identifier item information associated with the first object, wherein the item information comprises location information associated with the first object;
accessing a plurality of rules from a non-transitory data storage associated with the remote server;
identifying a first rule from the plurality of rules based at least in part on the item information, wherein the first rule comprises a flag associated with the first object, and wherein the flag identifies the first object as missing and comprises information associated with the first object;
identifying a first user based at least in part on the first rule;
generating and transmitting, via the remote server, a notification to a second electronic device, wherein the second electronic device is associated with the first user, and wherein the notification is associated with the first object and comprises at least a subset of the item information,
wherein the flag is configured to cause the object tracking system to automatically generate and transmit the notification to the second electronic device when first image associated with the first object is received.

18. The method of claim 17 further comprising receiving, via the remote server, device information from the first electronic device, the device information associated with the first electronic device.

19. The method of claim 18, wherein the device information associated with the first electronic device is captured and stored when the first image is captured and generated by the first electronic device.

20. The method of claim 17, wherein the notification can be at least one of the following: a text message, an email, a telephone call, or a notification on a mobile application.
